(19) United States
(12) Patent Application Publication
(10) Pub. No.: US 2003/0129101 A1
(43) Pub. Date: Jul. 10, 2003

(54) Catalytic monolith support system with improved thermal resistance and mechanical properties

(76) Inventor: Steven Zettel, Cranston, RI (US)

Correspondence Address: Bradley N. Ruben, 463 First Street, Suite 5A, Hoboken, NJ, 07030-1859, US

(21) Appl. No.: 10/043,587

(22) Filed: Jan. 10, 2002

(51) Int. Cl. B01D 53/88; F01N 3/28; F01N 7/14

(52) U.S. Cl. 422/179; 422/177; 422/180; 29/890

(57) ABSTRACT

The instant invention provides a new high temperature catalytic monolith support system which can be effectively utilized for sealing between the catalytic monolith and the housing of a catalytic converter, as well as physically cushioning the catalytic monolith within the housing. The support system preferably is made form wire mesh and a non-intumescent thermoresistant paper, in which the wire mesh and thermoresistant paper are integral and crimped together to produce a multi-herringbone configuration, providing multiple perpendicular barriers that prevent the gas-flow from bypassing the monolith.

### BACKGROUND

1. Field of Invention

The instant invention relates to high temperature resistant materials capable of withstanding continuous exposure to high temperatures, and more particularly to a high temperature resistant system for use in a catalytic converter for improved thermal insolation and mechanical performance.

2. State of the Art

Catalytic converters have generally been found to be effective for treating exhaust gases of internal combustion engines. In this regard, a conventional catalytic converter generally comprises a relatively fragile catalytic monolith including a ceramic monolithic support element for a catalyst, such as platinum, disposed in a metal housing (the “can”) with inlet and outlet ends, a support system to contain the catalyst substrate, and seals for keeping exhaust gasses within the housing. Substantially all of the exhaust gases entering the housing, and passing through the catalytic monolith, are converted to more benign affluents and exit through the tailpipe.

Until now, support systems for catalytic converters have generally been found to be less than satisfactory for cushioning the catalytic monolith against breakage from physical shocks, and for thermally insulating the catalytic monolith in the housing. It has been found that the deficiencies are at least partially due to the fact that only a limited number of materials can withstand the working temperature, up to about 1700° F., found in a catalytic converter. One of the most common materials utilized for such support systems is stainless steel wire, which is knitted, woven, or otherwise processed into a form that can be compacted into a desired configuration suitable for use in a catalytic converter. However, support systems made from stainless steel wire are inherently porous, having void spaces which permit certain quantities of exhaust gases to pass through. Additionally, wire mesh does not prevent heat transfer from the monolith to the outer shell; too much heat flow can degrade the outer shell, resulting in uncomfortably warm temperatures in the cab compartment. This loss of heat also reduces the effectiveness of the catalyst because its efficiency is better at higher temperatures. There have been some attempts at overcoming this heat loss by utilizing insolation materials. However, these materials are intumescent (i.e., they expand on heating), and require time and a build-up of temperature for them to expand. This raises cold-hold issues, compromising the effectiveness of the catalyst and the supporting seal, but only during initial engine start-up. Also, the intumescent material may not expand in a uniform manner, creating recovery problems as the can expands and contracts each time operating temperature is reached. Since the intumescent material only expands once, it is important that it be done properly the first time. However, due to the additional cost and labor expenditures involved, manufacturers prefer not to pre-expand it; which would require the new car owner to drive the vehicle for a sufficient time to reach operating temperature and expand the material.

With greenhouse gasses becoming increasingly detrimental to the Earth's environment, government regulations are continually raising the cleanliness requirements for automobile emissions. Accordingly, there is a recognized need for a more effective support system for the catalytic monolith of a catalytic converter to provide better thermal, mechanical, and sealing characteristics.

### OBJECTS AND SUMMARY OF THE INVENTION

Accordingly, it is one object of the instant invention to provide an improved effective support system for a catalytic converter which is capable of withstanding continuous exposure to extremely high temperatures.

A further object of the instant invention is to provide a thermal insulator and gaseous seal for a catalytic converter which is capable of effectively insulating the outer shell of the catalytic converter from the high temperatures of the catalytic monolith. As well as providing a good seal at cold temperatures without an intumescent material.

A further object of the instant invention is to provide a thermal insulator and gaseous seal for a catalytic converter which is capable of effectively increasing the temperatures within the catalytic monolith, especially during initial start-up of the engine, and ensuring that exhaust gasses pass through, rather than around, the catalytic monolith.

A further object of the instant invention is to provide an increased recovery characteristic both at ambient and high temperatures.

In one embodiment, the instant invention provides a new high temperature catalytic monolith support system which can be utilized for sealing between the catalytic monolith and the housing of a catalytic converter, as well as physically cushioning the catalytic monolith within the housing. The support system preferably is made from wire mesh and non-intumescent thermoresistant paper, in which the wire mesh and thermoresistant paper are crimped together to produce a multi-herringbone configuration, providing multiple perpendicular barriers that prevent the gas-flow from bypassing the monolith.

A high temperature resistant material of the above-described type can be utilized for fabricating a support system element which is capable of effectively sealing between the catalytic monolith of a catalytic converter and the housing, as well as for supporting the catalytic monolith in the housing. Further, a support system of the present invention is sufficiently resilient to enable it to cushion the catalytic monolith against breakage due to externally applied physical shocks.

Other objects, features and advantages of the instant invention shall become apparent as the description proceeds when considered in connection with the accompanying illustrative drawings.

### BRIEF DESCRIPTION OF THE DRAWINGS

FIG. 1 is a perspective view of a catalytic converter including the catalytic monolith support system of the instant invention;

FIG. 2 is a sectional view taken along Line 2-2 in FIG. 1;

FIG. 3 is an exploded perspective view of the catalytic converter;

FIG. 4 is a top view of the support system when laid flat; and

FIG. 5 is a sectional view taken along Line 5-5 in FIG. 4.

### DETAILED DESCRIPTION OF THE INVENTION

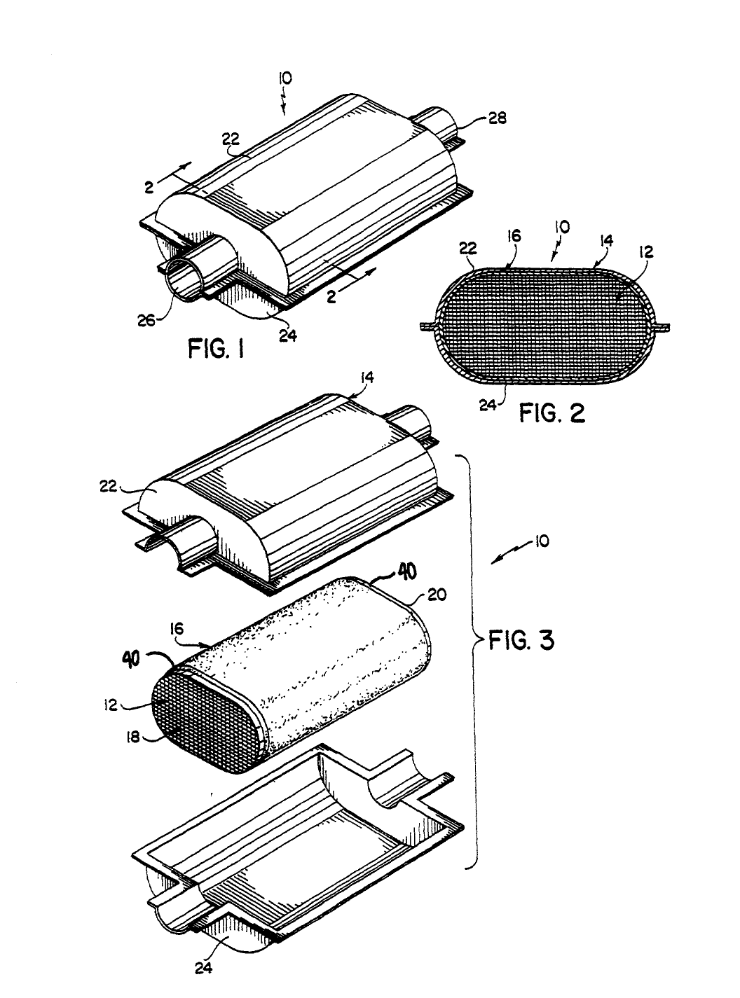

Referring now to the drawings, the catalytic converter of the instant invention is illustrated in FIGS. 1-3 and generally indicated at 10. The catalytic converter comprises a catalytic monolith generally indicated at 12, an outer housing generally indicated at 14, and a high temperature resistant support system generally indicated at 16. The support system is operative for thermally insulating between the catalytic monolith and the housing, as well as for cushioning the catalytic monolith, in order to prevent breakage resulting from externally applied physical shocks. Additionally, the support system 16 is operative as a gaseous seal for effectively ensuring that all or substantially all exhaust gasses pass through, rather than around, the catalytic monolith.

The catalytic monolith is of conventional construction, and comprises a monolith element which is formed in a honeycomb-like configuration from a material such as a high temperature resistant ceramic. The catalytic monolith further includes a catalyst, such as platinum, on the surfaces of the monolith element, so that high temperature gases exposed to those surfaces are catalytically converted as they pass through the catalytic monolith, effectively reducing the environmentally harmful exhaust gases emitted from the engine. The catalytic monolith 12 has an inlet end 18 and an outlet end 20, and is adapted to permit gases to pass freely from the inlet end to the outlet end, in order to expose the gases to the catalyst on the surfaces of the monolith element.

The housing 14 is also generally of a conventional configuration, and is formed from a suitable high temperature resistant metal, such as stainless steel. The housing includes first and second housing section halves 22, 24, which are secured together by suitable means, such as welding, so that they cooperate to form a housing for containing the catalytic monolith 12. In an alternate design, a monolith that has already been dressed with the support media is placed inside a round metal tube and the tube is swedged around the dressed monolith at a preset force. The metal tube that forms the housing has an inlet end and an outlet end and is constructed in such a way that gases entering the inlet end can pass through the catalytic monolith from its inlet end to the outlet end, and then through the outlet end of the housing. The housing has an inlet end 26 and an outlet end 28, and is constructed so that gases entering the inlet end 26 can pass through the catalytic monolith from its inlet end 18 to its outlet end 20, and then out through the outlet end 28 of the housing.

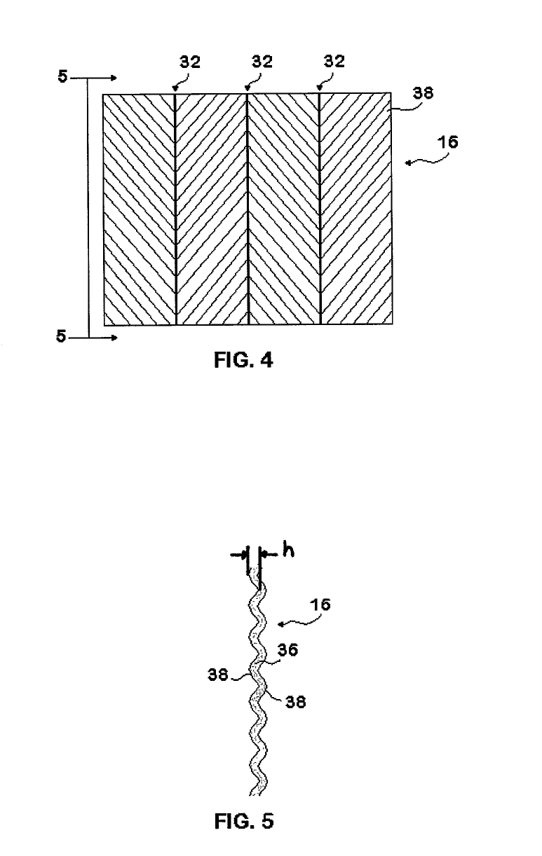

The support system 16 is formed using high temperature steel wire 38 that is formed against or around a flexible insolation material 36 (FIGS. 4 and 5). The steel wire, for example only, can be knitted, woven, crimped, wound, or otherwise processed into a form that can be compacted. The flexible insolation material is produced from refractory or non-refractory fibers, especially those that are body soluble such as a calcium-magnesium-silicate wool (e.g., SUPERWOOL brand, from Thermal Ceramics, Augusta, Ga.), which is flexible at ambient and elevated temperatures, and an organic binder in a unique paper making process. The particular binder material is preferably sacrificial in nature and is used only in the assembly process. However, it is the unique paper making process and fiber length that allows this insolation media to function at ambient temperatures as well as temperatures of up to 1700° F., with minimum out-gassing and using non-hazardous body soluble fibers. Additionally, the insolation material is most preferably of the non-intumescent type. Small amounts of an intumescent material can be used (e.g., less than 20% of the insolation material) in combination with the non-intumescent material, in which case some design modifications will be necessary. An improvement over the prior art is provided by the ability of the present support system to be installed at ambient temperatures, as it must be wrapped around the catalytic monolith 12 (FIG. 3), to seal while the engine is still cold (i.e., when the car is first started), and for cushioning and sealing at the elevated operating temperatures.

In order to provide the necessary cushioning for the catalytic monolith, the steel wire mesh and the material are crimped, preferably utilizing a multi-herringbone configuration with a multitude of perpendicular barriers, although other crimping and pleating geometries can be used. This structure can be made in many ways, such as placing the material between two layers of wire mesh, placing a single layer of wire mesh against the material, knitting the steel wire around and/or through the material, or any other process that would provide the sealing characteristics described herein. The actual crimping can be performed prior, during, or after the wire mesh and the material have been brought together, and the crimping height h (FIG. 5) can be varied to suit the needs of the particular catalytic monolith utilized. The wire mesh effectively protects the paper and provides the necessary cushioning, sealing, and/or support for the catalytic monolith.

Additionally, the arrangement and flexibility of the present invention provides a tight seal, which forces exhaust gas flow through the catalytic monolith rather than allowing it to pass between the support system and the catalytic monolith. As a result of directing preferably all of the exhaust gases through the catalytic monolith, efficiency is increased; since little or no exhaust gases bypass the catalytic monolith, all or substantially all of the exhaust gases are treated.

This sealing effect is accomplished by air blockage points 32, which are created during the crimping process. Effectively, the mold or stamp used to crimp the structure provides dams, or raised portions, that block and direct gas flow. Additionally or alternatively, end seals 40 (FIG. 3) may be placed at the inlet and outlet ends of the catalytic monolith between the support system and the can, thereby avoiding exhaust gases from bypassing the catalytic monolith.

The flexibility of insolation material allows it to fill in the empty spaces of the mesh, thereby preventing some of the heat, emanating from the catalyst, from reaching the outer metal skin of the converter can. This provides for an extended life span of the can, as well as reduced heat transfer from the converter into the cabin of the vehicle. This also allows for increased catalytic efficiency because the temperature inside the converter is kept at a higher level; the greater the temperature within the converter, the greater the catalytic conversion of the engine exhaust. Another important benefit of using this material is that it contains only a very small percentage of sacrificial binder. Thus, the material exhibits very low binder burn out, assuring material integrity throughout the entire life of the product, extending the life span of the material, and consequently the life span of the entire catalytic converter.

### EXAMPLE

For an example of the support system recovery from compression, a sample, with a wire having 0.014 in. diameter and a composite thermal paper made by Thermal Ceramics under the model number A286, was tested with several initial crimp heights ranging from 0.231 in. to 0.233 in. The results of the tests conducted at various temperatures and mechanical compression duration periods are shown in Table 1 below.

TABLE

| TEST TEMPERATURE (° F.) | INITIAL COMPRESSION | INITIAL RECOVERY | % RECOVERY LOSS |
|---|---|---|---|
| /DURATION | @ 0.165″ GAP (PSI) | @ 0.165″ GAP (PSI) | @ 0.165″ GAP (PSI) |
| Ambient | 63.4 | 38.5 | 39.3% |
| 1300/5 HRS | 64.0 | 49.1 | 23.3% |

The present arrangement has many advantages over the prior art, as discussed above. Additionally, the present invention is not effected by cold-hold issues, which are a problem with prior art systems using intumescent sealing material; such prior art systems are ineffectual until the temperature rises sufficiently to allow for the intumescent material to expand and form an effective seal. The present invention, on the other hand, utilizes a non-intumescent sealing material that holds its shape, and is thereby effective from the initial start-up. A further advantage over the prior art is that the non-intumescent material of the present invention is made using a very small amount of organic material (about 3% latex), and so the structural integrity of the sealing material is maintained after sacrifice of the binder. In contrast, prior art devices that utilize about 12% binder in their manufacture have relatively short-term effect; as the binder is burned out, the structural integrity and insolation effect of the material deteriorate.

While there is shown and described herein certain specific structure embodying the invention, it will be manifest to those skilled in the art that various modifications and rearrangements of the parts may be made without departing from the spirit and scope of the underlying inventive concept, and that the same is not limited to the particular forms shown and described herein, except insofar as indicated by the scope of the appended claims.

What is claimed is:

1. A support system for a catalytic monolith, comprising:
a. wire arranged to provide cushioning support and/or gaseous sealing for said catalytic monolith;
b. insolation material comprising predominantly non-intumescent material and arranged integral with said wire to provide thermal insolation and/or gaseous sealing for said catalytic monolith.

2. The support system for a catalytic monolith according to claim 1, wherein said wire is arranged as a wire mesh.

3. The support system for a catalytic monolith according to claim 2, wherein said wire mesh is crimped, so as to provide at least one barrier to gasses, support, and/or cushioning for said catalytic monolith.

4. The support system for a catalytic monolith according to claim 3, wherein said wire mesh is crimped in a multi-herringbone configuration.

5. The support system for a catalytic monolith according to claim 3, wherein said at least one barrier includes an air blockage points, so as to direct gases through said catalytic monolith.

6. The support system for a catalytic monolith according to claim 1, further comprising an end seal proximal to said wire so as to direct gases through said catalytic monolith.

7. The support system for a catalytic monolith according to claim 6, wherein said end seal is proximal to a gas inlet and/or outlet of said catalytic monolith.

8. The support system for a catalytic monolith according to claim 1, wherein said insolation material is a ceramic.

9. The support system for a catalytic monolith according to claim 8, wherein said insolation material is flexible at ambient temperatures.

10. The support system for a catalytic monolith according to claim 8, wherein said insolation material is at least 95% non-intumescent.

11. The support system for a catalytic monolith according to claim 8, wherein said insolation material is 100% non-intumescent.

12. The support system for a catalytic monolith according to claim 9, wherein said insolation material is flexible at temperatures from about 0° F. to about 1700° F.

13. The support system for a catalytic monolith according to claim 8, wherein said insolation material includes refractory ceramic fibers.

14. The support system for a catalytic monolith according to claim 2, wherein said wire is arranged as a plurality of sheets of wire mesh, and said insolation material sandwiched between said plurality of sheets of wire mesh.

15. The support system for a catalytic monolith according to claim 2, further comprising a end seal proximal to said wire mesh and/or insolation material.

16. A method of providing a support system for a catalytic monolith, comprising the steps of:
a. providing a wire;
b. arranging said wire to provide cushioning support and/or gaseous sealing for said catalytic monolith;
c. providing insolation material of predominantly non-intumescent material; and
d. arranging said insolation material integral with said wire to provide thermal insolation and/or gaseous sealing for said catalytic monolith.

17. The method of providing a support system for a catalytic monolith according to claim 16, further comprising the step of crimping said wire mesh, so as to provide at least one barrier to gasses, support, and/or cushioning for said catalytic monolith.

18. The support system for a catalytic monolith according to claim 17, wherein said at least one barrier includes an air blockage points, so as to direct gases through said catalytic monolith.

19. The method of providing a support system for a catalytic monolith according to claim 16, further comprising the step of crimping said wire mesh in a multi-herringbone configuration, so as to provide at least one barrier to gasses, support, and/or cushioning for said catalytic monolith.

20. The support system for a catalytic monolith according to claim 19, wherein said at least one barrier includes an air blockage points, so as to direct gases through said catalytic monolith.
